(19) United States
(12) Patent Application Publication
(10) Pub. No.: US 2006/0195877 A1
(43) Pub. Date: Aug. 31, 2006

(54) Convergence system and method

(76) Inventor: William George Bentz, Laurel, MD (US)

Correspondence Address: William G. Bentz, 8106 Shannon's Alley, Laurel, MD, 20724, US

(21) Appl. No.: 11/065,609

(22) Filed: Feb. 25, 2005

(51) Int. Cl. H04N 7/173; H04N 7/025; H04N 7/10

(52) U.S. Cl. 725/110; 725/112; 725/113; 725/32

(57) ABSTRACT

One embodiment of a method may provide, through a convergence system, a browser having a first start page and a second start page. The method may present, through the convergence system, the first start page, in response to a viewer selection of (i) a first television channel and (ii) the browser. The method may present, through the convergence system, the second start page, in response to a viewer selection of (i) a second television channel and (ii) the browser.

### FIELD OF THE INVENTION

The present invention relates in general to a convergence system and method.

### DESCRIPTION OF BACKGROUND INFORMATION

Television is the most lucrative entertainment medium. The networks'business model, however, needs to be changed, as the network faithful are dwindling and billions of yearly advertising dollars that, among other things, finances many television programs are in jeopardy. The network viewership has fallen over the past decade by an average of about 2% per year, and it is accelerating. For example, in the 2003-04 season, the drop was 7% among younger viewers, the audience advertisers most want to reach. Audiences tend to look elsewhere for entertainment when shows and/or schedules do not work. The networks are going to have trouble down the road if they do not keep their viewers and/or get viewers back. Otherwise, the networks will have to contend with even more viewership erosion, which translates to fewer opportunities to promote their shows. Ultimately, smaller and smaller audiences mean fewer and fewer advertising dollars, which is network television's lifeline. Accordingly, new ways are needed to insure the future profitability, and viability, of the television business.

### BRIEF DESCRIPTION OF THE DRAWINGS

In the drawings, like reference numerals represent similar parts of the illustrated embodiments of the present invention throughout the several views and wherein:

FIGS. 1 and 2 depict exemplary embodiments of a method;

FIG. 3 depicts one embodiment of framing online content;

FIG. 4 depicts one embodiment of a method that presents one or more programs and/or commercials and one or more indications;

FIG. 5 depicts a plurality of indications for a plurality of extranets;

FIG. 6 depicts one embodiment of a method that presents one or more programs and/or commercials and an indication for an extranet, depending upon a viewer selection of a television channel;

FIG. 7 depicts a plurality of indications for a plurality of intranets;

FIG. 8 depicts one embodiment of a method that presents one or more programs and/or commercials and an indication for an intranet, depending upon a viewer selection of a television channel;

FIG. 9 depicts a plurality of indications for a plurality of portals;

FIG. 10 depicts one embodiment of a method that presents one or more programs and/or commercials and an indication for a portal, depending upon a viewer selection of a television channel;

FIGS. 11-13 depict exemplary embodiments of a portal;

FIG. 14 depicts one embodiment of a convergence system; and

FIG. 15 depicts one embodiment of a convergence system receiving content from one or more sources.

### DETAILED DESCRIPTION

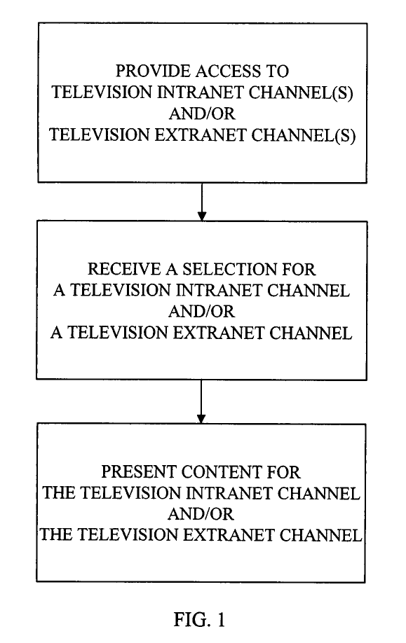

FIG. 1 illustrates an exemplary method that may provide access to a plurality of television intranet channels and/or television extranet channels. The method may receive a viewer selection for a television intranet channel and/or a television extranet channel from the plurality of television intranet channels and/or television extranet channels. The method may present content for the television intranet channel and/or the television extranet channel. The content may include broadcast and/or online content. A first content may offer, for example, high quality video, and a second content may offer, for example, interactivity to viewers. The online content may also provide a gateway to the internet.

A start page may be accessed to begin the use of an intranet(s), an extranet(s) and/or the internet. The start page may include a search engine and/or an answer engine to locate information and/or resources. A viewer may also select a link and/or type into a browser an address to access information and/or resources.

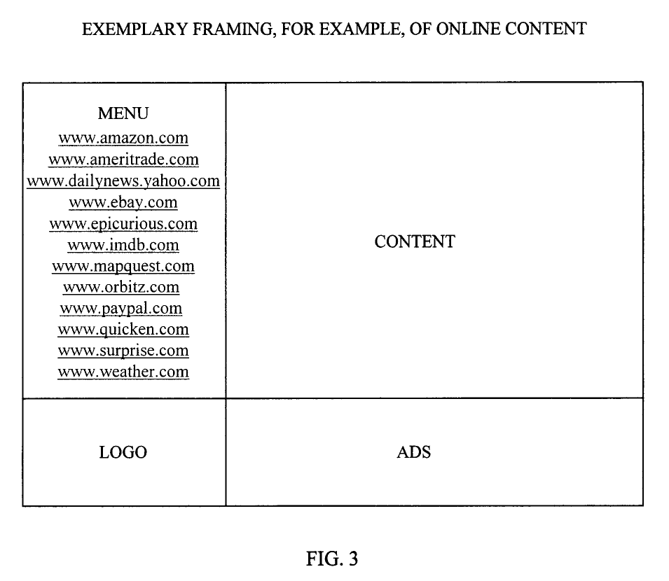

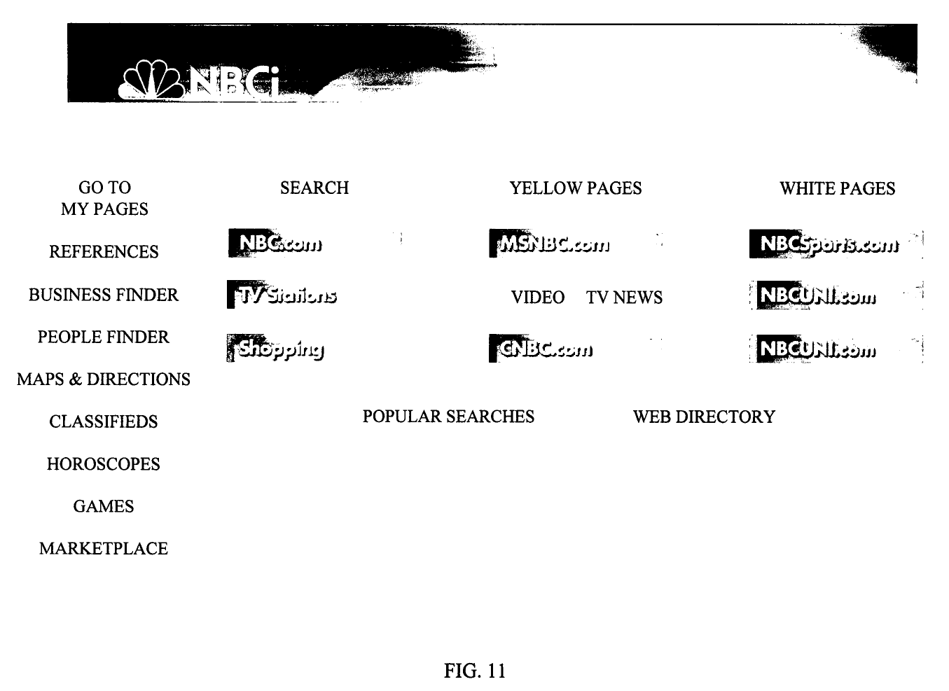

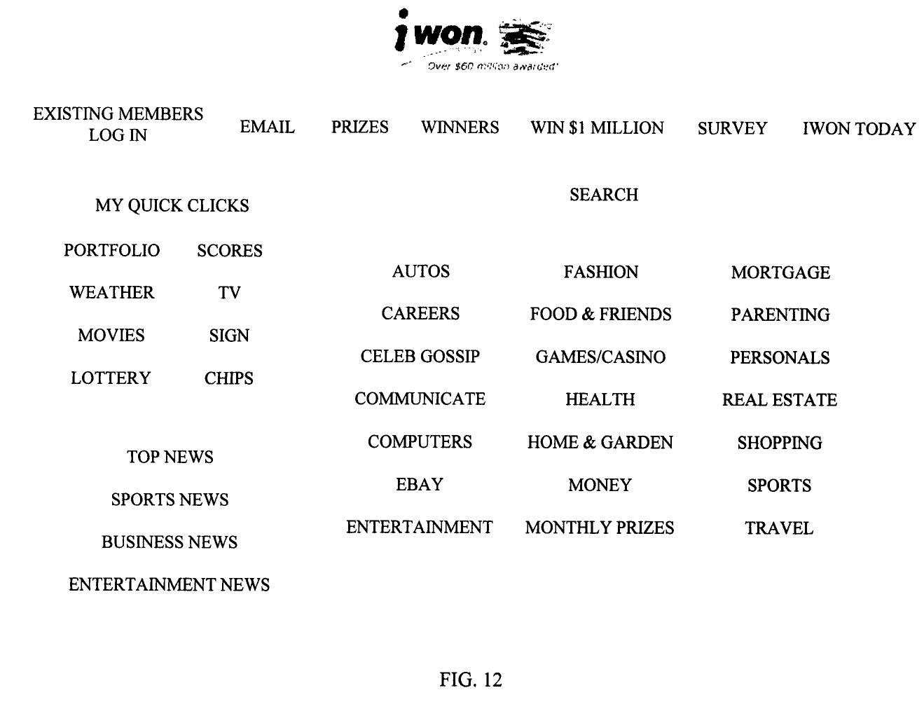

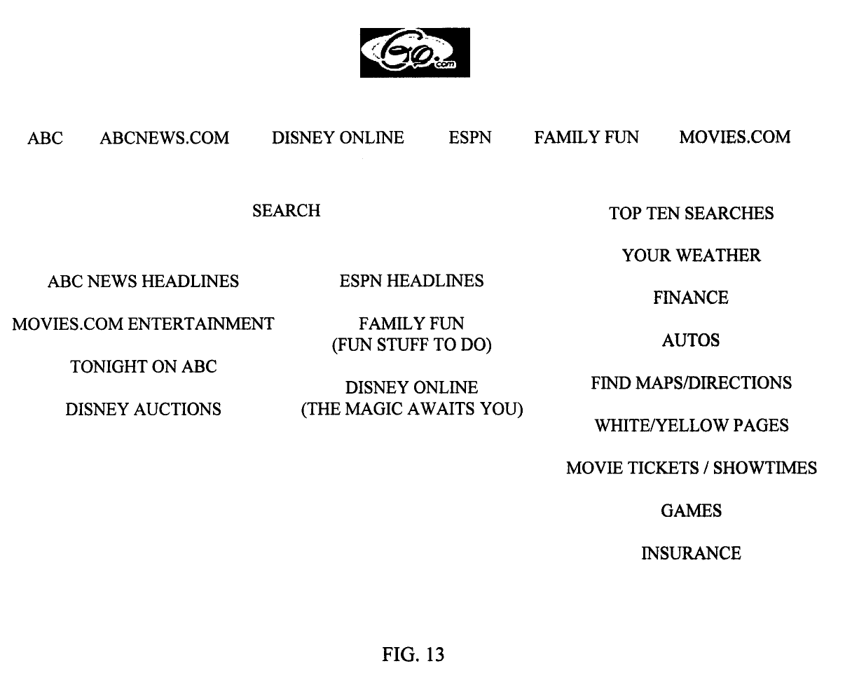

The start page may include a portal (see, for example, FIGS. 11-13) to access online services, products and/or resources. The start page may also provide the framing of online content (see, for example, FIG. 3). The framing, for example, may allow a plurality of web sites to be viewed while they are framed with information from another web site.

An intranet and/or an extranet may be a television channel-centric tool. The intranet may be used to put services, products and/or resources out to viewers of a particular television channel, and the extranet may be used to put services, products and/or resources out to viewers of one or more of a plurality of television channels.

A portal may be a viewer-centric tool. The portal may allow viewers to access services, products and/or resources provided by one or more television channels and/or to customize a portal interface, for example, to include other services, products and/or resources within the portal interface.

An intranet(s), an extranet(s) and/or a portal(s) may provide a competitive advantage, for example, to a television network. The television experience may be enhanced by allowing viewers to switch between watching television and surfing an intranet(s), an extranet(s) and/or the internet, and/or do both simultaneously, for example, with picture-in-picture. A television channel(s) may provide television programming and one or more online services, products and/or resources such as, for example, online content, search engine, links, games, contest/sweepstakes, greetings/postcards, online storage, photo center, chat, e-mail, video-mail, instant messaging, bulletin boards, utilities, applications, commerce, streaming audio, streaming video and/or other features such as on demand programming.

The intranet(s) and/or the extranet(s) may be tools to decide to whom a collection of services, products and/or resources should be made available, and to whom access should be restricted. An intranet may be a set of services, products and/or resources shared by, and/or limited to, a group that, for example, are tuned to a particular television channel. An extranet may be a set of services, products and/or resources shared by, and/or limited to, a group that, for example, are tuned to one or more of a plurality of television channels, all of which may or may not be associated with a particular television network. The intranet(s) and/or the extranet(s) may provide a finite and/or targeted amount of content, for example, so as not to be confused with a useless information superhighway—as some have referred to the internet.

The content associated with the intranet(s) and/or the extranet(s) may travel across private networks (e.g., a corporate intranet and/or extranet) and/or public networks (e.g., the internet infrastructure). The intranet(s) and/or the extranet(s) may or may not provide a link to the internet, which is accessible to the general public.

An intranet(s) and/or an extranet(s), for example, may be cost effective, easily updatable, easy to deliver information, basically secure, relatively easy to configure, use and/or manage, well suited for multi-media applications, effective for reducing printing costs and/or distribution time, able to run across a variety of platforms, and/or easy for users (e.g., many of which may already have experience in them). Cache hit rate opportunities may also be higher for an intranet(s) and/or an extranet(s) compared to the internet, so online content of the intranet(s) and/or the extranet(s) may be downloaded faster.

A portal may be a horizontal portal such as, for example, a general-purpose portal, and/or a vertical portal such as, for example, a niche portal. A portal may bring together a wide range of services such as, for example, products, resources, applications, tools and/or other features. For example, the portal may provide news, finance, sports, entertainment, music, games, ring tones, auctions and/or shopping. The portal may be customized to allow a viewer to influence the substance and/or the presentation of the viewer's portal. The portal may also provide a gateway to the internet.

General Electric, Viacom and Walt Disney have spent north of hundreds of millions of dollars on internet portals and, yet, have been unable to profit from them. So far, NBCi (which is General Electric's internet portal), iWon (which is Viacom's internet portal) and Go.com (which is Disney's internet portal) have been miserable investments for the media companies, in part, as they continue to be undiscovered by the public. The media companies, however, may combine their internet portals with one or more of their television channels to create new business opportunities that generates profits. A portal may be used to attract and/or keep a larger audience at a television channel (or vice versa), and may also be a gateway to redirect traffic to other online services, products and/or resources such as, for example, other web sites.

A horizontal portal may be a service that offers an array of resources such as, for example, online access, content, products, tools, forums, shopping and/or search. The portal may include advertisements, and may provide various types of information such as, for example, news, entertainment, weather and/or stock quotes. The portal may also post links to various web sites, and/or provide games, music, audiobooks, subject directories, e-mail services, online chat rooms and/or message boards, instant messaging and/or search engine functions. The search engine may include meta search engines to combine the results of other searchable sites. In addition, the portal may be customized, for example, with links to other sites. Examples of internet portals include iWon.com, NBCi, Go.com, StartSpot, Alta Vista, Lycos, Excite, Yahoo!, AOL, and MSN.

A vertical portal (“vortal”) may be a service that provides information and/or resources for a particular industry. The vortal may provide news, research, statistics, discussions, newsletters, tools, and/or other features about an industry. Examples of internet vortals include eFreeMarket, MacLaunch, ZDNet, and the web sites indicated by StartSpot.

A portal(s), in combination with a television channel(s), may allow media companies to gain a competitive advantage as they may leverage their content, brands and/or other assets to lure more viewers and advertiser dollars. The portal(s) may be used to form alliances with other players on the internet to drive viewers to a television channel(s). The portal(s) may provide ads, and may also be used to get people to visit a plurality of destinations, for example, determined by a television network.

The portal(s) may include a search engine that, for example, a media company may use to pitch online advertising, for example, through sponsored keyword searches. The portal(s) may be used to sell merchandise, for example, from e-commerce partners. The portal(s) may also profit from subscriber internet sites, which may pay a television network to be included into a portal's search engine, ads, and/or links to increase their chance of receiving hits. For example, a viewer may access a portal(s) to seek a site that sells books, and may submit the term “BOOKS” to a search engine. One or more book sellers that subscribe to the portal(s) may then be displayed for the viewer, who may select an internet site to make a purchase.

The portal(s) may provide one or more modules, including news, stock quotes, weather, traffic cams and/or search utility. The module(s) may be added, modified, removed and/or substituted to provide applications, information and/or processes on one or more topics. The portal(s) may be used with any type of network such as, for example, the internet, a local area network (“LAN”) and/or a wide area network (“WAN”).

An intranet(s), an extranet(s), a portal(s) and/or a start page(s) may create a property for a television network(s) that may swap traffic and/or provide cross-selling opportunities with a television channel(s), and/or vice versa. The intranet(s), the extranet(s), the portal(s) and/or the start page(s) may allow the television network(s) to garner a slice, for example, of online advertising and/or electronic commerce dollars, and an opportunity to expand their business.

A convergence system may include capabilities that may otherwise be provided by separate systems. The convergence system may include a television and a set-top box coupled to the television. The set-top box may decode television broadcast that may be delivered through service providers such as, for example, cable companies, satellite operators and/or direct broadcast reception via traditional antennas and/or rabbit ears. Cable service may require the installation of a dedicated cable to a subscriber's residence. Satellite broadcast service may require that a viewer have a satellite dish, for example, located on or somewhere close to a residence. The term broadcast may include cablecast, narrowcast, network multicast, push technology, and/or other variations, for example, of simultaneous information distribution to a plurality of recipients.

The set-top box may include one or more input ports such as, for example, a port for a satellite antenna dish, a port for a terrestrial antenna, a port for a cable link and a port for a network connection (e.g., intranet, extranet and/or internet connection). The set-top box may also include an output port for connection to the television. The convergence system may also bring together other consumer electronic devices such as, for example, DVD players and/or recorders, telephones, cameras, and/or game modules. A viewer may access the inputs and/or devices, for example, through a remote control and/or a keyboard.

A television (and/or other consumer electronic device(s)) coupled to a set-top box and/or a built-in may be used as an on-line access device to communicate over a network, as is well-known in the art. The convergence system may provide a browser such as, for example, MSN TV browser, Internet Explorer, Netscape, Firefox, Mozilla, Opera, and/or Voyager, to navigate web documents such as, for example, web pages that may be linked to each other via hyperlinks. The web pages may contain graphics, sounds, text and/or video. The convergence system may allow online content to be navigated and/or broadcast content to be watched, or simultaneously do both, for example, by displaying broadcast television within a window of a web page.

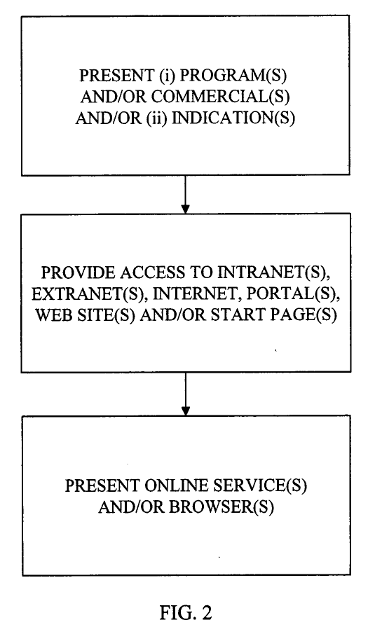

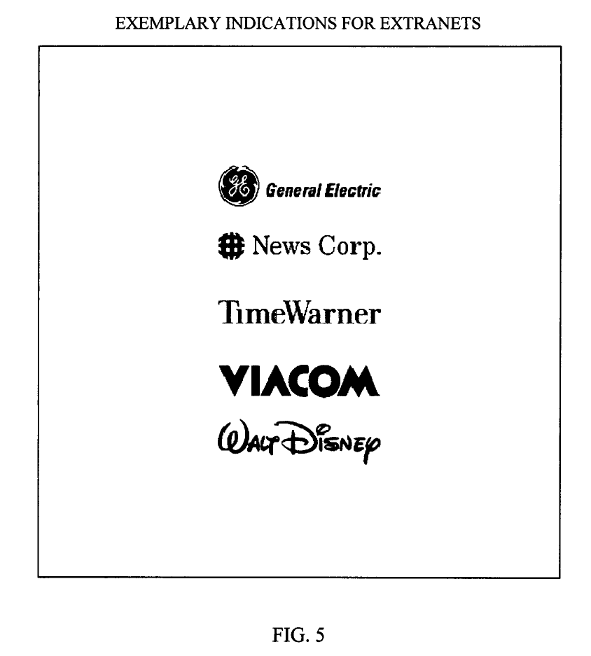

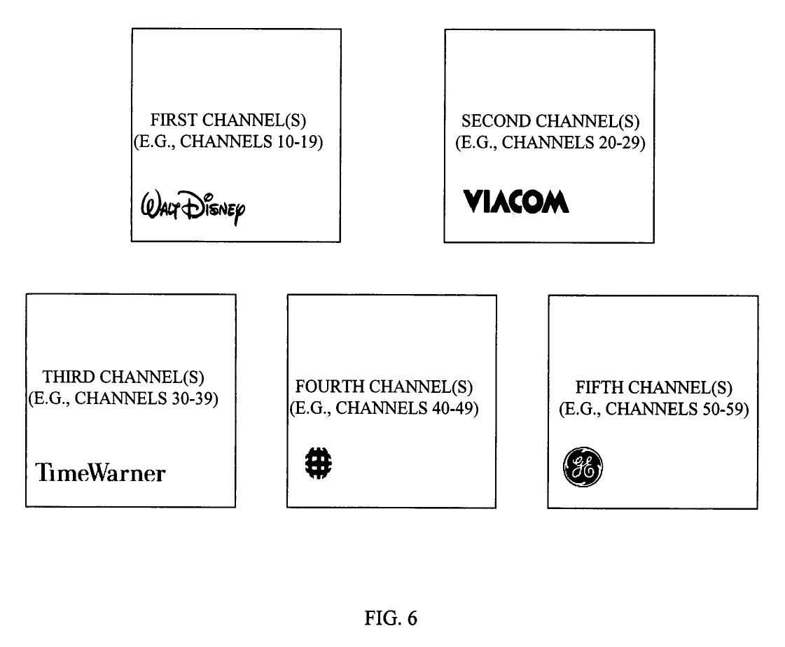

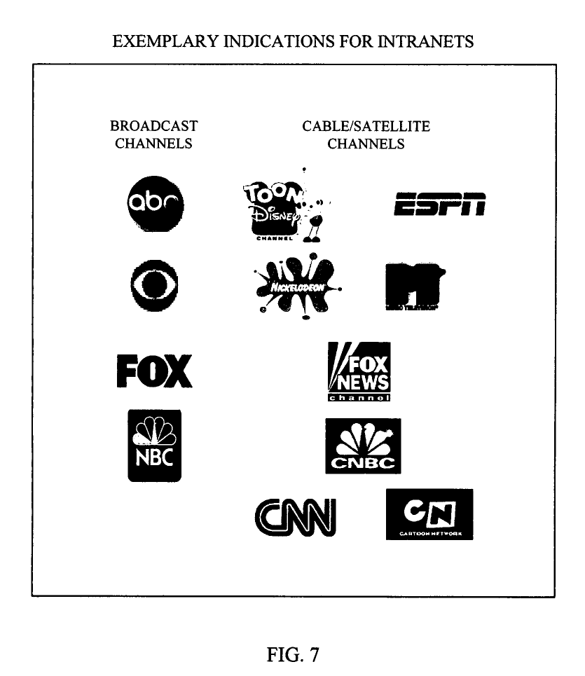

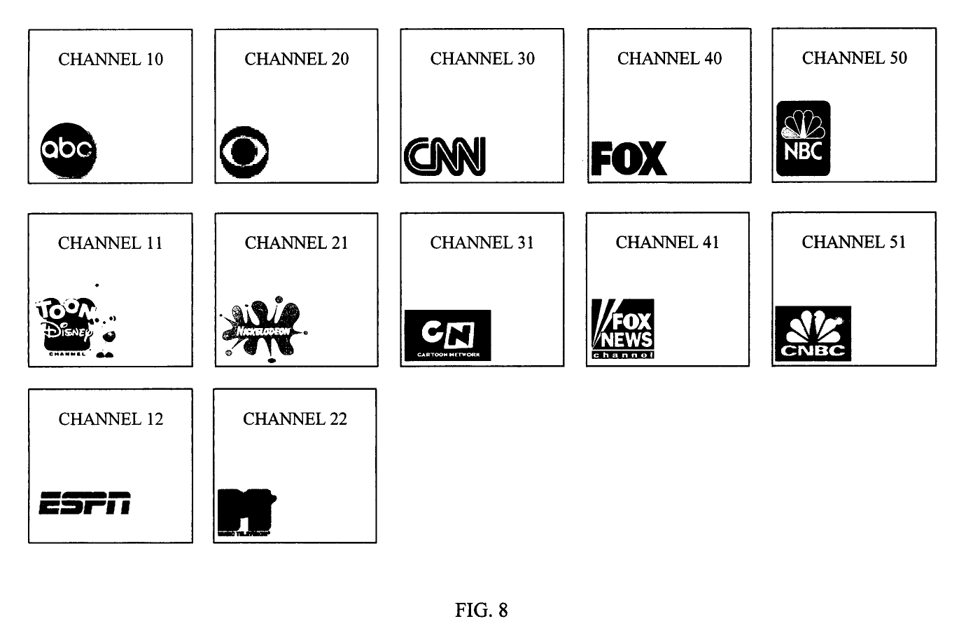

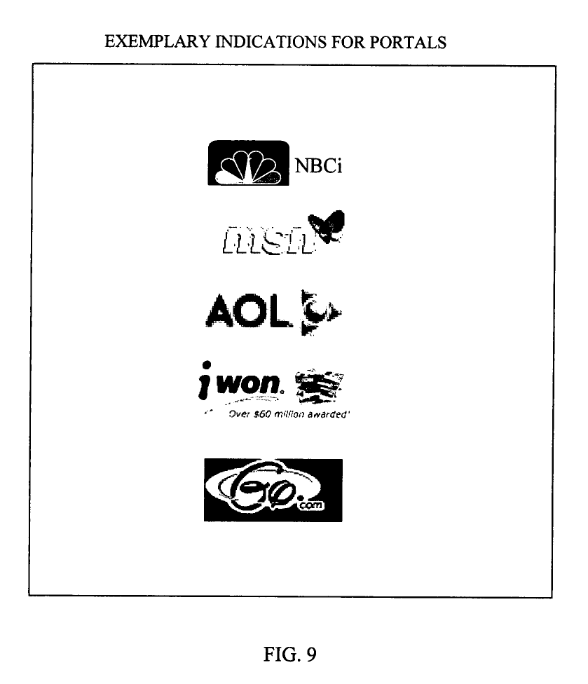

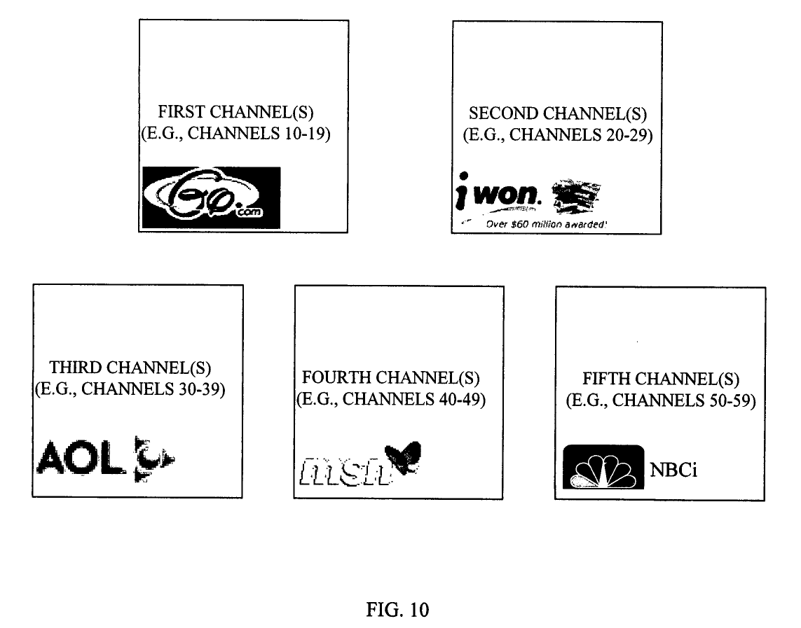

An exemplary combination (see, for example, FIGS. 1-15) may include one or more of the following:
A method may present, through a convergence system, (i) one or more programs and/or commercials and (ii) an indication for a browser, by a television channel. The method may present, through the convergence system, a start page, by a viewer selection of (i) the television channel and (ii) the browser;
A method may provide a browser having a first start page and a second start page. The method may present, through a convergence system, the first start page, in response to a viewer selection of (i) a first television channel and (ii) the browser. The method may present, through the convergence system, the second start page, in response to a viewer selection of (i) a second television channel and (ii) the browser;
A method may provide a browser having a first start page and a second start page. The method may present a first indication for the first start page by at least selecting a first television channel. The method may present a second indication for the second start page by at least selecting a second television channel. The first start page may be assigned to the first television channel, and the second start page may be assigned to the second television channel;
A method may provide a browser having a first start page and a second start page. The method may present, through the browser, one of (i) the first start page and (ii) the second start page by at least selecting one of one or more first television channels. The method may present, through the browser, the other of (i) the first start page and (ii) the second start page by at least selecting one of one or more second television channels;
A method may provide, through a television, access to a first portal, in response to a viewer selection of a first television channel. The method may provide, through the television, access to a second portal, in response to a viewer selection of a second television channel. The first television channel may be assigned to provide (e.g., by using the first portal) (i) first broadcast content and/or (ii) access to first online content. The second television channel may be assigned to provide (e.g., by using the second portal) (i) second broadcast content and/or (ii) access to second online content;
A method may provide, through a convergence system, access to a first intranet, depending upon a viewer selection of at least one of one or more first television channels. The method may provide, through the convergence system, access to a second intranet, depending upon a viewer selection of at least one of one or more second television channels. The method may present, through the convergence system, a first online service, depending upon a viewer selection of (i) the at least one of one or more first television channels and (ii) the first intranet. The method may present, through the convergence system, a second online service, depending upon a viewer selection of (i) the at least one of one or more second television channels and (ii) the second intranet;
A method may provide, through a convergence system, access to a first extranet, depending upon a viewer selection of at least one of one or more first television channels. The method may provide, through the convergence system, access to a second extranet, depending upon a viewer selection of at least one of one or more second television channels. The method may present, through the convergence system, a first online service, depending upon a viewer selection of (i) the at least one of one or more first television channels and (ii) the first extranet. The method may present, through the convergence system, a second online service, depending upon a viewer selection of (i) the at least one of one or more second television channels and (ii) the second extranet; and/or
A method may present, through a convergence system, a first indication for a first intranet and/or a first extranet, depending upon a viewer selection of at least one of one or more first television channels. The method may present, through the convergence system, a second indication for a second intranet and/or a second extranet, depending upon a viewer selection of at least one of one or more second television channels. The one or more first television channels may be assigned to provide (e.g., by using the first intranet and/or the first extranet) (i) first broadcast content and/or (ii) access to first online content. The one or more second television channels may be assigned to provide (e.g., by using the second intranet and/or the second extranet) (i) second broadcast content and/or (ii) access to second online content. The first television channels and/or the second television channels may include an on-demand television channel.

The first start page and/or the second start page may provide framing of online content. One or more television networks and/or viewers may select at least one of (i) a first web site to be the first start page and (ii) a second web site to be the second start page. The first start page may be a first internet portal, a first intranet portal and/or a first extranet portal, and the second start page may be a second internet portal, a second intranet portal and/or a second extranet portal. The first web site, the second web site, the first television channel(s) and/or the second television channel(s) may be owned, in part or in whole, by at least one of (i) General Electric, (ii) News Corp., (iii) TimeWarner, (iv) Viacom and (v) Walt Disney.

The first indication and/or the second indication may include a link, an icon, and/or a digitally originated graphic (“DOG”). The first indication may include a logo of the first television channel, and the second indication may include a logo of the second television channel. The first indication may also include a logo of a first web site selected as the first start page, and the second indication may include a logo of a second web site selected as the second start page.

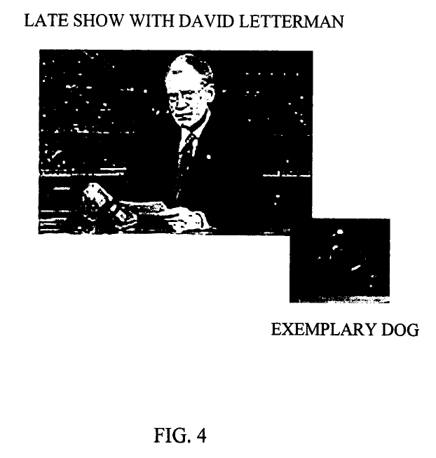

The programs, commercials and/or indications may be presented through a first window, and the online services may be presented through a second window, for example, as in picture-in-picture (“PIP”) and/or picture-outside-picture (“POP”). The indications may be animated and/or may appear as overlays on the programs and/or commercials. The indications may be used as (i) advertisement and/or branding for a television channel(s), an intranet(s), an extranet(s), the internet, a portal(s), a web site(s) and/or a start page(s), and/or (ii) an indication of the availability of an intranet(s), an extranet(s), the internet, a portal(s), a web site(s) and/or a start page(s), for example, for a television channel(s). A DOG may be a logo on a screen, for example, as illustrated by FIG. 4.

Frames may divide a web page into multiple regions, sections and/or windows that may operate independently of each other. Frames may be used to create regions that may contain, for example, text, graphics and/or links. One or more frames and/or windows may display different web pages. A first frame may be utilized as a region for displaying information such as, for example, web sites. Other frames may be utilized for displaying a logo, links to web sites and/or other information (e.g., television programming), and/or ads.

A method that includes framing may incorporate and/or pull in an entire external web site, or portions thereof, and surround it with frames. For example, if a viewer wants to purchase a plane ticket, the viewer may click on a link for www.orbitz.com on a start page of a television channel that calls up the orbitz web site within a frame on the start page of the television channel. The viewer may view the information on one or more linked sites, for example, without having to leave the start page. The framing may allow the viewer to stay at the start page to view the orbitz web site, rather than jumping to orbitz's own web site.

An intranet(s), an extranet(s), the internet, a portal(s), a web site(s) and/or a start page(s), in combination with a television channel(s), provide the television networks a way to differentiate their offerings, reach new audiences, increase brand preference and usage, attract more advertisers, and/or sell new real estate for online ads and/or services. The intranet(s), the extranet(s), the internet, the portal(s), the web site(s) and/or the start page(s) may transform the television business by making the television experience better and more enjoyable for viewers and the business proposition richer for television networks. Broadcasters and content providers may engage television viewers, for example, in unique, relevant and/or useful ways.

The intranet(s), the extranet(s), the internet, the portal(s), the web site(s) and/or the start page(s), in combination with the television channel(s), may provide the television networks a way to add new revenue streams such as, for example, online advertising dollars and/or online content-for-pay dollars. In 2003, online advertising spending hit $8.3 billion. By 2008, PricewaterhouseCoopers forecasts that online advertising will total $11.4 billion. The Online Publishers Association says that online content-for-pay revenue is growing significantly: it hit $746 million in the first half of 2003, up 23% from the same period in 2002. Also, the intranet(s), the extranet(s), the internet, the portal(s), the web site(s) and/or the start page(s) may add online ad revenue to the networks'coffers, for example, without eating up their available broadcast commercial time, thereby making expensive commercial spots still available. The intranet(s), the extranet(s), the internet, the portal(s), the web site(s) and/or the start page(s), in combination with the television channel(s), may be offered to viewers for free and/or for a fee as part of a subscription.

The intranet(s), the extranet(s), the internet, the portal(s), the web site(s) and/or the start page(s) may also allow online companies to form alliances with the television networks, for example, to become one of a finite number of web sites easily available to viewers of a television channel(s) that increases the chances of “hits” for the participating web sites and, ultimately, their revenues.

The television networks may include, for example, General Electric, Viacom, Disney, News Corp, TimeWarner and/or other known networks. The television channels may include any known television channel, for example, one or more television channels owned by the television networks. General Electrics owns, in part or in whole, NBC, CNBC, MSNBC, Court TV, Bravo, A&E, History Channel, Sci-Fi, USA, mun2, and Telemundo. Viacom owns, in part or in whole, CBS, MTV, VH-1, Nickelodeon, Comedy Central, BET, UPN, Country Music Television, The Nashville Network, Showtime, The Movie Channel, Sundance Channel, and Flix. Disney owns, in part or in whole, ABC, ESPN, Lifetime Television, A&E, History Channel and E! News Corp. owns, in part or in whole, FOX, The Golf Channel, Fox News Channel, Fox Movie Channel, FX, National Geographic Channel, SPEED Channel, Fox Sports, and Sunshine Network. TimeWarner owns, in whole or in part, TNT, CNN, HBO, Cinemax, TBS Superstation, Turner Network Television, The WB, Turner Classic Movies, Warner Brothers Television, Cartoon Network, Sega Channel, Comedy Central, E!, and Court TV.

A convergence system such as, for example, a television coupled to a set-top box, may be used to access a service(s) of the intranet(s), the extranet(s), the internet, the portal(s), the web site(s) and/or the start page(s) associated with one or more television channel(s). The convergence system may include one or more features of conventional internet terminals, for example, that use a television as a monitor such as MSN TV by Microsoft. If a viewer has call waiting and gets a phone call while online, the convergence system may pause to allow the incoming call. After completing the call, the convergence system may automatically re-establish the online connection and return to the online content that was previously being viewed.

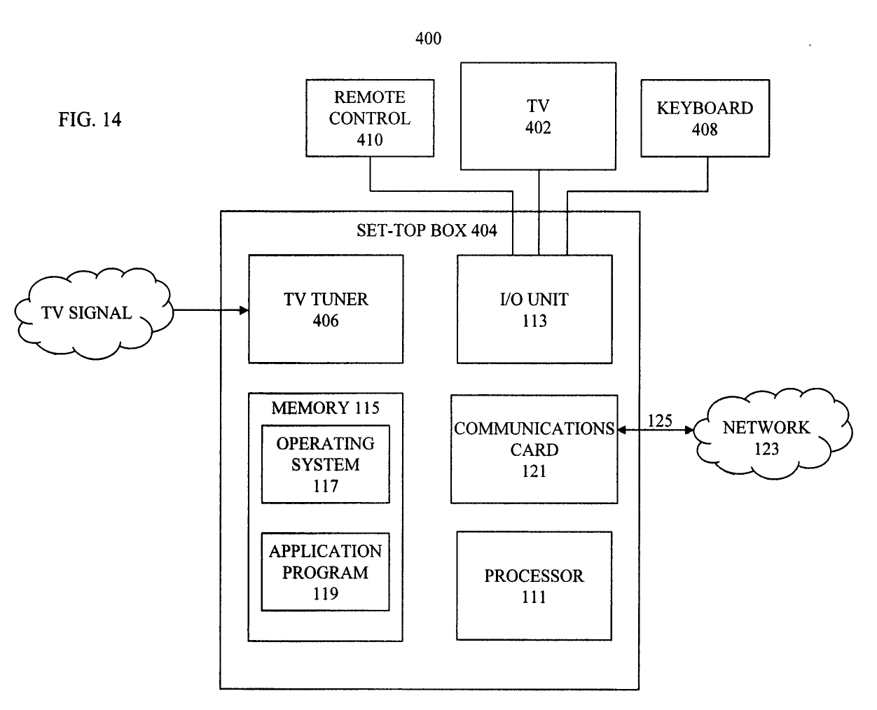

FIG. 14 illustrates one embodiment of a system 400 to make, for example, one or more usages of a television 402. A viewer, for example, may watch television and/or access online content (e.g., web pages). A computer 404 such as, for example, a set top box 404 may be used with the television 402 to view the online content. The set-top box 404 may include a central processor unit 111, an input/output (“I/O”) unit 113, a memory 115, a communications card or device 121, and/or a television tuner 406. The memory 115 may store data and various programs such as, for example, an operating system 117 and one or more application programs 119. The communications card or device 121 may include a modem and/or a network adapter, and may exchange data with a network 123 via a communications link 125. The network 123 may include the internet, an intranet and/or an extranet, and the communications link 125 may include a telephone and/or cable line. The television tuner 406 may receive television programming in the form of broadcast, satellite, and/or cable television signals. The set top device 404 may be configured to selectively display one or more different sources of content (e.g., television programming received by the television tuner 406 and/or web pages received by the communications card 121) on the television 402.

The system 400 may include a keyboard 408 and/or a remote control 410. The keyboard 408 and/or the remote control 410 may be wireless and include specialized keys to make television viewing and/or web surfing easier.

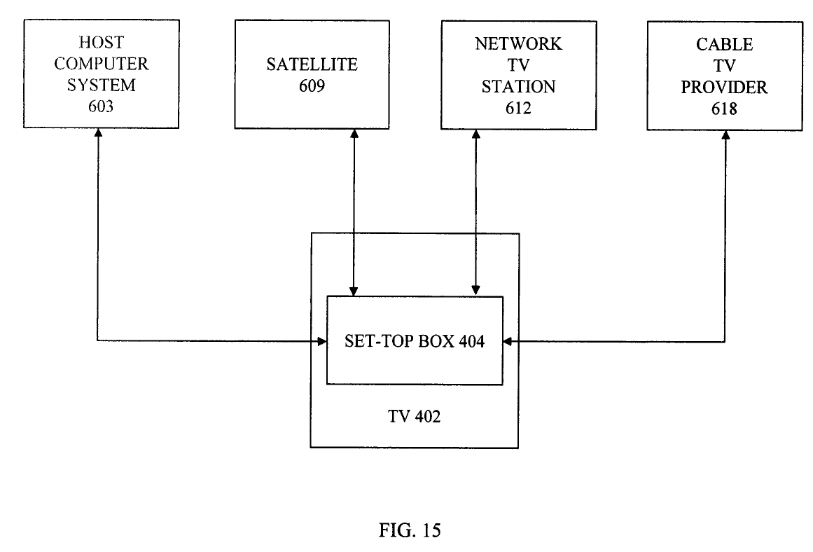

FIG. 15 illustrates that the set top box 404 may gather content from one or more sources. The set top box 404 may gather content from (i) a host computer system 603 via a public and/or private network and telephone and/or cable lines, (ii) a satellite 609, (iii) a network television broadcast 612 using microwave and/or wireless communications, and/or (iv) a cable television provider 618 by direct cabling. The transport mechanisms illustrated in FIG. 15 are exemplary only, as any available transport mechanism may be used to receive content from one or more sources.

The host computer 603 may provide online services such as, for example, e-mail, e-commerce, chat rooms, online access and content, electronic newspapers and magazines, etc. The set top box 404, for example, may communicate with one or more server systems 603 through a modem, a phone line, and/or a direct connection using a protocol such as, for example, Transport Control Protocol/Internet Protocol (“TCP/IP”).

A browser may be used to access and view electronic content stored locally and/or remotely such as, for example, in a network environment. The browser may display documents, for example, described in Hyper-Text Markup Language (“HTML”) and stored on one or more servers connected to the network.

A viewer may instruct the browser to access an HTML document (e.g., a web page), for example, by specifying a network address (e.g., Uniform Resource Locator (“URL”)) at which a desired document resides. In response, the browser may contact the corresponding server hosting the requested web page, retrieve the one or more files that make up the web page, and display the web page in a window on the viewer's display.

A web page may be composed of one or more files potentially of one or more data types such as, for example, text, graphics, images, virtual worlds, sounds, and/or movies. The web page may also include links pointing to other resources (e.g., web pages and/or individual files) available on a network. The links (and/or indications) may take any visual form. For example, the links (and/or indications) may appear as a text string and/or a graphical image. A link may have an associated URL pointing to a location on the network. When a viewer selects a displayed link, the browser may automatically retrieve the web page (or other resource) corresponding to the link's associated URL and execute it and/or display it to the viewer.

One embodiment of the convergence system may allow a viewer to select a television channel from a plurality of television channels and, in response, provide television programming and/or online browsing for the television channel. A start page for the television channel may be displayed, for example, through a browser. The start page may provide, in part or in whole, the television programming and/or the online browsing.

A start page may appear when a browser is started, and/or a television channel is changed. For example, a browser may include one or more start pages that may be assigned to one or more television channels. A viewer may return to a start page for a television channel, for example, by selecting the television channel and/or “Home” for the television channel on the browser. The one or more start pages may be changed and/or restored. For example, a television network may change a start page of a television channel, depending upon the television programming and/or one or more viewers.

A machine-readable medium having encoded information, which when read and executed by a machine causes, for example, a method (e.g., one or more described embodiments). The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., a convergence system). The machine may comprise one or more microprocessors, microcontrollers, and/or other arrays of logic elements.

In view of the foregoing, it will be apparent to one of ordinary skill in the art that the described embodiments may be implemented in software, firmware, and/or hardware. The actual software code or specialized control hardware used to implement the described embodiments is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments based on the description herein.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and features disclosed in any fashion herein.

What is claimed is:

1. A method comprising:
providing, through a convergence system, a browser having a first start page and a second start page;
presenting, through the convergence system, the first start page, in response to a viewer selection of (i) a first television channel and (ii) the browser; and
presenting, through the convergence system, the second start page, in response to a viewer selection of (i) a second television channel and (ii) the browser.

2. The method of claim 1, further comprising
framing online content by at least one of (i) the first start page and (ii) the second start page.

3. The method of claim 1, further comprising
selecting, by a television network, at least one of (i) a first web site to be the first start page and (ii) a second web site to be the second start page.

4. The method of claim 1, further comprising
selecting, by a first television network, a first web site to be the first start page; and
selecting, by a second television network, a second web site to be the second start page.

5. The method of claim 1, further comprising
selecting, by a viewer, at least one of (i) a first web site to be the first start page and (ii) a second web site to be the second start page.

6. The method of claim 1, wherein at least one of (i) the first television channel and (ii) the second television channel is owned, in part or in whole, by one of (i) General Electric, (ii) News Corp., (iii) TimeWarner, (iv) Viacom and (v) Walt Disney.

7. The method of claim 1, wherein (i) a first web site selected to be the first start page and (ii) the first television channel are owned, in part or in whole, by one of (i) General Electric, (ii) News Corp., (iii) TimeWarner, (iv) Viacom and (v) Walt Disney.

8. The method of claim 1,
wherein the first start page is a first internet portal, and
wherein the second start page is a second internet portal.

9. The method of claim 1,
wherein the first start page is a first intranet portal, and
wherein the second start page is a second intranet portal.

10. The method of claim 1,
wherein the first start page is a first extranet portal, and
wherein the second start page is a second extranet portal.

11. The method of claim 1, wherein at least one of (i) the first start page and (ii) the second start page is a portal.

12. A method comprising:
providing a browser having a first start page and a second start page;
presenting a first indication for the first start page by at least selecting a first television channel; and
presenting a second indication for the second start page by at least selecting a second television channel.

13. The method of claim 12,
wherein the first start page is assigned to the first television channel, and
wherein the second start page is assigned to the second television channel.

14. The method of claim 13, wherein at least one of (i) the first indication and (ii) the second indication is a link.

15. The method of claim 13, wherein at least one of (i) the first indication and (ii) the second indication is a DOG.

16. The method of claim 13,
wherein the first indication includes a logo of the first television channel, and
wherein the second indication includes a logo of the second television channel.

17. The method of claim 13,
wherein the first indication includes a logo of a first web site selected as the first start page, and
wherein the second indication includes a logo of a second web site selected as the second start page.

18. A method comprising:
providing a browser having a first start page and a second start page;
presenting, through the browser, one of (i) the first start page and (ii) the second start page by at least selecting one of one or more first television channels; and
presenting, through the browser, the other of (i) the first start page and (ii) the second start page by at least selecting one of one or more second television channels.

19. The method of claim 18,
wherein the first television channels are owned, in part or in whole, by a first company, and
wherein the second television channels are owned, in part or in whole, by a second company.

20. The method of claim 19,
wherein the first company is one of (i) General Electric, (ii) News Corp., (iii) TimeWarner, (iv) Viacom and (v) Walt Disney, and
wherein the second company is a different one of (i) General Electric, (ii) News Corp., (iii) TimeWarner, (iv) Viacom and (v) Walt Disney.

21. The method of claim 18,
wherein the first start page is at least one of (i) a first internet portal, (ii) a first intranet portal and (iii) a first extranet portal, and
wherein the second start page is at least one of (i) a second internet portal, (ii) a second intranet portal and (iii) a second extranet portal.

22. A method comprising:
providing, through a television, access to a first portal, in response to a viewer selection of a first television channel; and
providing, through the television, access to a second portal, in response to a viewer selection of a second television channel.

23. The method of claim 22,
wherein the first television channel is assigned to provide (i) first broadcast content and (ii) access, by using the first portal, to first online content, and
wherein the second television channel is assigned to provide (i) second broadcast content and (ii) access, by using the second portal, to second online content.

24. The method of claim 23,
wherein at least one of (i) the first portal and (ii) the second portal is at least one of (i) an internet portal, (ii) an intranet portal and (iii) an extranet portal, and
wherein at least one of (i) the first television channel and (ii) the second television channel is at least one of (i) NBC, (ii) ABC, (iii) CBS and (iv) FOX.

25. The method of claim 23,
wherein the first portal and the first television channel are owned, in part or in whole, by one of (i) General Electric, (ii) News Corp., (iii) TimeWarner, (iv) Viacom and (v) Walt Disney, and
wherein the second portal and the second television channel are owned, in part or in whole, by a different one of (i) General Electric, (ii) News Corp., (iii) TimeWarner, (iv) Viacom and (v) Walt Disney.

26. The method of claim 23, wherein the first television channel and the second television channel are owned, in part or in whole, by at least one of (i) General Electric, (ii) News Corp., (iii) TimeWarner, (iv) Viacom and (v) Walt Disney.

27. The method of claim 23,
wherein the first portal is NBCi, and
wherein the first television channel is NBC.

28. The method of claim 23,
wherein the first portal is go.com, and
wherein the first television channel is ABC.

29. The method of claim 23,
wherein the first portal is iwon, and
wherein the first television channel is CBS.

30. The method of claim 23,
wherein the first portal is AOL, and
wherein the first television channel is owned, in part or in whole, by TimeWarner.

31. A method comprising:
providing, through a convergence system, access to a first intranet, depending upon a viewer selection of at least one of one or more first television channels; and
providing, through the convergence system, access to a second intranet, depending upon a viewer selection of at least one of one or more second television channels.

32. The method of claim 31, further comprising
presenting, through the convergence system, a first online service, depending upon a viewer selection of (i) the at least one of one or more first television channels and (ii) the first intranet; and
presenting, through the convergence system, a second online service, depending upon a viewer selection of (i) the at least one of one or more second television channels and (ii) the second intranet.

33. The method of claim 31, wherein at least one of (i) the first television channels and (ii) the second television channels are owned, in part or in whole, by at least one of (i) General Electric, (ii) News Corp., (iii) TimeWarner, (iv) Viacom and (v) Walt Disney.

34. A method comprising:
providing, through a convergence system, access to a first extranet, depending upon a viewer selection of at least one of one or more first television channels; and
providing, through the convergence system, access to a second extranet, depending upon a viewer selection of at least one of one or more second television channels.

35. The method of claim 34, further comprising
presenting, through the convergence system, a first online service, depending upon a viewer selection of (i) the at least one of one or more first television channels and (ii) the first extranet; and
presenting, through the convergence system, a second online service, depending upon a viewer selection of (i) the at least one of one or more second television channels and (ii) the second extranet.

36. The method of claim 34, wherein at least one of (i) the first television channels and (ii) the second television channels are owned, in part or in whole, by at least one of (i) General Electric, (ii) News Corp., (iii) TimeWarner, (iv) Viacom and (v) Walt Disney.

37. A method comprising:
presenting, through a convergence system, a first indication for a first intranet and/or a first extranet, depending upon a viewer selection of at least one of one or more first television channels; and
presenting, through the convergence system, a second indication for a second intranet and/or a second extranet, depending upon a viewer selection of at least one of one or more second television channels.

38. The method of claim 37,
wherein the one or more first television channels is assigned to provide (i) first broadcast content and (ii) access, by using the first intranet and/or the first extranet, to first online content, and
wherein the one or more second television channels is assigned to provide (i) second broadcast content and (ii) access, by using the second intranet and/or the second extranet, to second online content.

39. The method of claim 38, wherein at least one of (i) the first indication and (ii) the second indication is a link.

40. The method of claim 38, wherein at least one of (i) the first indication and (ii) the second indication is a DOG.

41. The method of claim 38, wherein at least one of (i) the one or more first television channels and (ii) the one or more second television channels is owned, in part or in whole, by at least one of (i) General Electric, (ii) News Corp., (iii) TimeWarner, (iv) Viacom and (v) Walt Disney.

42. The method of claim 37, wherein the first television channels and the second television channels include an on-demand television channel.

43. A method comprising:
providing access to a plurality of television intranet channels;
receiving a selection for a television intranet channel from the plurality of television intranet channels; and
presenting content for the television intranet channel.

44. The method of claim 43, further comprising
framing online content for the television intranet channel.

45. A method comprising:
providing access to a plurality of television extranet channels;
receiving a selection for a television extranet channel from the plurality of television extranet channels; and
presenting content for the television extranet channel.

46. The method of claim 45, further comprising
framing online content for the television extranet channel.

47. A method comprising:
providing access to a television intranet channel and a television extranet channel;
receiving a viewer selection for at least one of the television intranet channel and the television extranet channel; and
presenting content for at least one of the television intranet channel and the television extranet channel, depending upon the viewer selection.

48. A method comprising:
presenting, through a convergence system, (i) one or more programs and/or commercials and (ii) an indication for a browser, by a television channel; and
presenting, through the convergence system, a start page, by a viewer selection of (i) the television channel and (ii) the browser.

49. The method of claim 48, wherein the start page is at least one of (i) an intranet portal and (ii) an extranet portal.

50. The method of claim 48, wherein the start page is a portal.

51. The method of claim 50, wherein the television channel and the portal are owned, in part or in whole, by the same company.

52. The method of claim 50, wherein the television channel is at least one of (i) NBC, (ii) ABC, (iii) CBS and (iv) FOX.

53. The method of claim 50,
wherein the portal is NBCi, and
wherein the television channel is NBC.

54. The method of claim 50,
wherein the portal is go.com, and
wherein the television channel is ABC.

55. The method of claim 50,
wherein the portal is iwon, and
wherein the television channel is CBS.

56. The method of claim 50,
wherein the portal is AOL, and
wherein the television channel is owned, in part or in whole, by TimeWarner.

57. The method of claim 50, wherein the indication includes a DOG reflecting a logo of the portal.

58. The method of claim 50, wherein the indication includes at least one of (i) a link, (ii) an icon and (iii) a DOG.

59. The method of claim 50, further comprising
framing online content by the portal.
